(19) United States
(12) Patent Application Publication
(10) Pub. No.: US 2021/0346732 A1
(43) Pub. Date: Nov. 11, 2021

(54) FILTERING MASK WITH COMPARTMENT FOR REPLACEABLE FILTER

(71) Applicant: beyondSMART Furniture Co., Ltd., Shenzhen (CN)

(72) Inventors: Jiawei Tu, Nanping City (CN); Wenji Tang, Shenzhen City (CN); Ken Partyka, Edmond, OK (US)

(73) Assignee: beyondSMART Furniture Co., Ltd., Shenzhen (CN)

(21) Appl. No.: 17/039,633

(22) Filed: Sep. 30, 2020

Related U.S. Application Data
(63) Continuation-in-part of application No. 29/737,343, filed on Jun. 8, 2020.

(30) Foreign Application Priority Data
May 7, 2020 (CN) 202020737935.9
May 7, 2020 (CN) 202030200723.2

(51) Int. Cl. A62B 23/02; A62B 18/02

(52) U.S. Cl. CPC A62B 23/02; A62B 18/025

(57) ABSTRACT

A filtering mask for use with a replaceable filter includes a mask body, a filter passage formed through the mask body, a first filter frame positioned within the filter passage, and a filter compartment cover, including a ventilation hole through the filter compartment cover, covering the filter passage. The filter passage may define in part a filter compartment and a replaceable filter may be positioned on the first filter frame within the filter compartment. A filter gap may be defined between the first filter frame and the filter compartment cover, and one or more filter frames, lights, fragrances, or other accessories or components may be positioned within the filter gap. The filter compartment cover may be removably lockable to the mask body, for replacing the filter.

### CROSS-REFERENCE TO RELATED APPLICATIONS

This application is a continuation-in-part of and claims priority to U.S. application Ser. No. 29/737,343 filed Jun. 8, 2020. This application claims priority to CN Patent Application Nos. 202020737935.9 filed May 7, 2020 and 202030200723.2 filed May 7, 2020. Each of the applications listed above is incorporated herein by reference in their entirety.

### BACKGROUND OF THE DISCLOSURE

Human development has been accompanied in recent years by health crises involving communicable infectious diseases such as SARS in 2003, H1N1 in 2009, and COVID-19 in 2019-2020. Continuing global interaction and other factors suggest that the future includes the real possibility of further airborne infectious conditions. In addition, human activities, including industrialization and the burning of fossil fuels, and natural disasters, such as wildfires, also present respiratory risk of chronic illnesses and conditions in individuals.

Accordingly, safety against pollutants and airborne pathogens is increasingly important and valued by people, and wearing a mask has in many ways become, and will remain, a new normal. In many regions of the world, protective masks have already become a basic necessity just like clothes and shoes and, normally, we do not throw away clothes or shoes until they are worn out. As such, non-disposable masks present a beneficial option for respiratory protection. Further, the global face mask industry is burgeoning, and the increased production, sale, and use of masks as a fashion item is further motivation for the use of non-disposable masks. Typically, reusable masks may be, e.g., electric masks which increase ventilation by adding fans. Since many such reusable masks are directed to preventing smoke and pollutant inhalation, these masks may not effectively protect against airborne pathogens. These types of masks are also commonly designed for medical, industrial, and emergency response applications, and may not themselves be good foundations for fashionable design.

With regard to disposable masks, prudent replacement requires frequently disposing of the disposable masks. Even reusable cloth masks must be machine or hand washed and therefore require time in which the mask is not usable. These processes lead to increased waste from disposable masks and detergents for washing cloth masks.

In view of the deficiencies above, an effective protective mask that does not generate the waste of disposing of a full mask or require machine/wet washing of a cloth mask, and that has the opportunity for optimum protection with fashionable and fun aspects, will be beneficial.

### BRIEF DESCRIPTION OF THE EXEMPLARY EMBODIMENTS

In an aspect, the disclosure relates to a filtering mask for use with a replaceable filter. The filtering mask may include a mask body with a filter passage formed through the mask body, from an outside opening of the filter passage to an inside opening of the filter passage. The filter passage may be bounded by a sidewall extending from an outer surface of the mask body to an inner surface of the mask body, and a first filter frame may be positioned adjacent to the inside opening of the filter passage. The sidewall, the first filter frame, and the filter passage may define a filter compartment. A filter compartment cover including a ventilation hole through the filter compartment cover may include a portion positioned within the filter passage, and a filter gap may be defined between the first filter frame and the filter compartment cover.

In another aspect, the disclosure relates to a filtering mask structure for use with a replaceable filter. The filtering mask structure may include a mask body including an outer surface and an inner surface, and a filter passage formed through the mask body. The filter passage may be open to an outside of the mask body and an inner side of the mask body and bounded by a sidewall extending from the outer surface of the mask body to the inner surface of the mask body. The sidewall may include a sidewall slot formed in the sidewall. A first filter frame covering a portion of the filter passage at the inner side of the mask body, along with the mask body and the sidewall, may be integrally formed as a unitary structure.

In another aspect, the disclosure relates to a light insert for use with a filtering mask. The light insert may include a printed circuit board (PCB) cooperatively dimensioned with a filter compartment of the filtering mask, for the PCB to be received within the filter compartment. An airflow gap may be formed through the PCB and a light source may be provided thereon. A controller may be electrically connected to the PCB and operative to control operation of the light source.

### BRIEF DESCRIPTION OF THE DRAWINGS

A more particular description will be rendered by reference to exemplary embodiments that are illustrated in the accompanying figures. Understanding that these drawings depict exemplary embodiments and do not limit the scope of this disclosure, the exemplary embodiments will be described and explained with additional specificity and detail through the use of the accompanying drawings in which:

FIG. 1 is a front-bottom perspective view of an outside of a filtering mask body and filter compartment according to an exemplary embodiment(s);

FIG. 2A is a rear view of an inner side of a filtering mask according to an exemplary embodiment(s);

FIG. 2B is a rear-top perspective view of a filtering mask according to an exemplary embodiment(s);

FIG. 2C is a left side view of a filtering mask body according to an exemplary embodiment(s);

FIG. 2D is a right side view of a filtering mask body according to an exemplary embodiment(s);

FIG. 2E is a bottom view of a filtering mask according to an exemplary embodiment;

FIG. 2F is a top view of a filtering mask according to an exemplary embodiment;

FIG. 3 is a front-bottom perspective view of a filtering mask body and filter compartment according to an exemplary embodiment;

FIG. 4 is a front-bottom perspective view of a filtering mask according to an exemplary embodiment;

FIG. 5 is a bottom perspective view of a filter compartment cover for a filtering mask according to an exemplary embodiment;

FIG. 6 is a detail view according to feature ‘B’ in FIG. 1, showing a sidewall slot of a filtering mask body according to an exemplary embodiment;

FIG. 7A is a front view of a filtering mask according to an exemplary embodiment;

FIG. 7B is a cross-sectional view along line A-A in FIG. 7A;

FIG. 8 is a filter frame according to an exemplary embodiment;

FIG. 9A is a light for use with a filtering mask according to an exemplary embodiment; and

FIG. 9B is a cross-sectional view of a portion of a filter gap housing a light according to an exemplary embodiment.

Various features, aspects, and advantages of the exemplary embodiments will become more apparent from the following detailed description, along with the accompanying drawings in which like numerals represent like components throughout the figures and detailed description. The various described features are not necessarily drawn to scale in the drawings but are drawn to aid in understanding the features of the exemplary embodiments.

The headings used herein are for organizational purposes only and are not meant to limit the scope of the disclosure or the claims. To facilitate understanding, reference numerals have been used, where possible, to designate like elements common to the figures.

### DETAILED DESCRIPTION

Reference will now be made in detail to various exemplary embodiments. Each example is provided by way of explanation and is not meant as a limitation and does not constitute a definition of all possible embodiments. Variations consistent with the disclosure may include, for example, different configurations, geometries, dimensions, and materials of components and systems, and techniques, mechanisms, and orders of processes and for functions.

Embodiments described herein relate generally to devices, systems, and methods for a mask with a filter compartment for a replaceable filter. For purposes of this disclosure, the phrases “devices,” “systems,” and “methods” may be used either individually or in any combination referring without limitation to disclosed components, grouping, arrangements, steps, functions, or processes.

For purposes of this disclosure, relative terms such as “above,” “below,” “between,” “adjacent,” and the like are used to aid in the description of the exemplary embodiments and are not limiting with respect to any particular configurations, boundaries, or dimensions, except where the disclosure otherwise makes expressly clear.

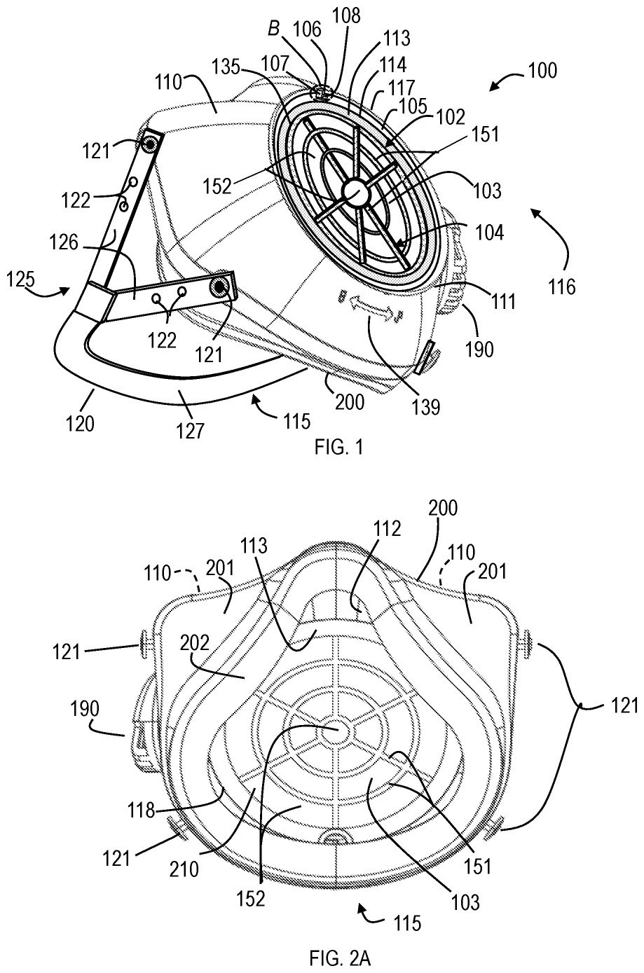

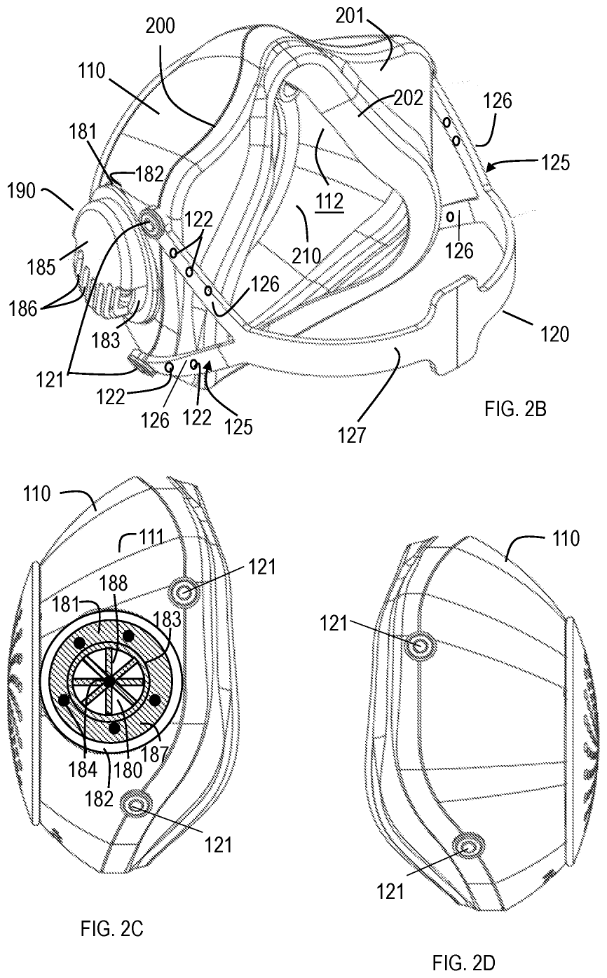

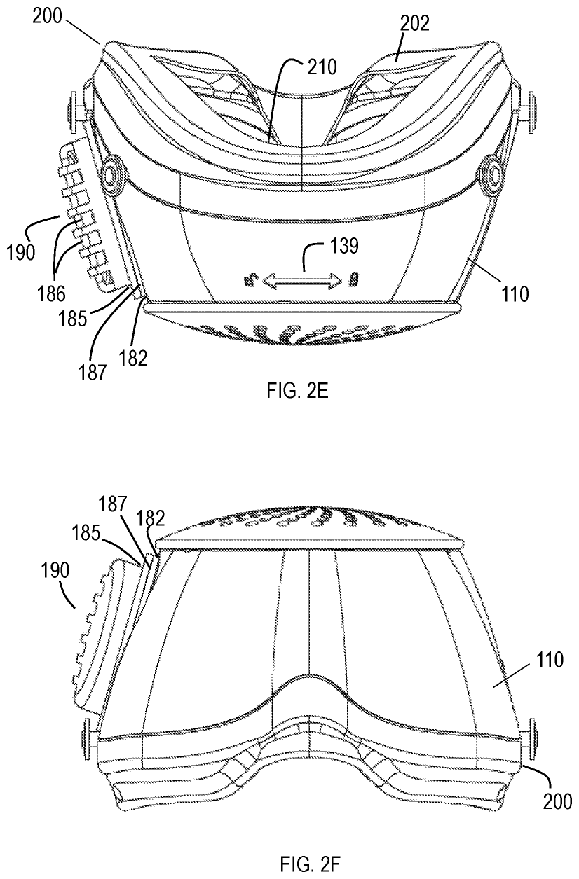

With reference now to FIG. 1, an exemplary embodiment of a filtering mask 100 for use with a replaceable filter includes, among other things, a mask body 110 and a filter passage 103 through the mask body 110. With additional reference to FIG. 2A, the filter passage 103 is formed all the way through the mask body 110, from an outside opening 117 of the filter passage 103 to an inside opening 118 of the filter passage 103. The filter passage 103 is bounded by a sidewall 105 that defines a periphery of the filter passage 103 and extends from an outer surface 111 of the mask body 110 to an inner surface 112 of the mask body 110. The filter passage 103 thereby opens an inner side 115 of the mask body 110 to an outside 116 of the mask body 110. For purposes of this disclosure, “inner” or “inside,” such as in, e.g., “inside opening 118,” “inner surface 112,” and “inner side 115,” generally refers to portions nearest a user's face when wearing the mask, while “outside” or “outer,” such as in, e.g., “outside opening 117,” “outer surface 111,” and “outside 116 of the mask body 110,” generally refers to portions furthest from the user's face or exposed to the environment outside of the mask.

The mask body 110 in the exemplary embodiments is formed from a rigid but lightweight material such as a plastic that may be, without limitation, an injection molded plastic. In an aspect, the mask body 110 is rigid and durable enough to accommodate and support the components and features of the exemplary mask 100 and functions thereof as discussed throughout this disclosure. Accordingly, the mask body 110 may be formed from any material and by any technique consistent with this disclosure and as particular applications may require.

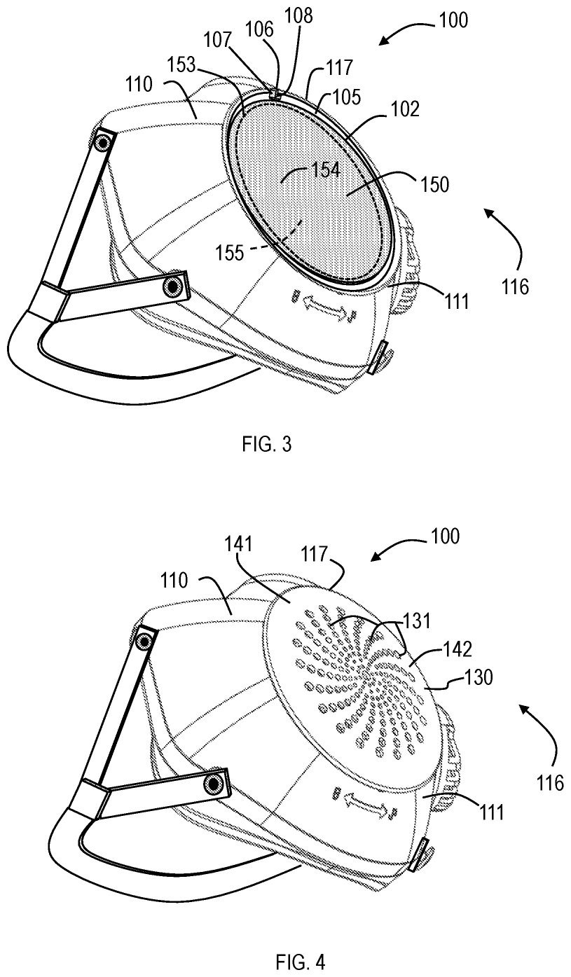

A first filter frame 104 is positioned adjacent to the inside opening 118 of the filter passage 103 and the sidewall 105, the first filter frame 104, and the filter passage 103 define a filter compartment 102 for housing, without limitation, a replaceable filter 150 (FIG. 3). For purposes of this disclosure, “adjacent” is not particularly limiting but read in the context of the disclosure. For example, the first filter frame 104 being “adjacent” to the inside opening 118 of the filter passage may include the first filter frame 104 positioned within the filter passage 103 above the inside opening 118, formed integrally with the inner surface 112 of the mask body 110 below the filter passage 103, or generally connected and/or positioned with respect to the inside opening 118 of the filter passage 103 such as to in-part define the filter compartment 102, consistent with the disclosure.

The first filter frame 104 includes, in the exemplary embodiments shown in FIGS. 1 and 2A, a web of solid supports 151 positioned within a peripheral wall 135 of the first filter frame 104, and gaps 152 through the first filter frame 104, between the solid supports 151. The solid supports 151 provide a surface on which the replaceable filter 150 may be positioned. The gaps 152 provide airflow paths through the filter passage 103 in use. The first filter frame 104 may be integrally formed, e.g., by injection molding, or the various components may be assembled or attached in any known manner consistent with this disclosure. In an exemplary embodiment, the first filter frame 104 is formed from, without limitation, a rigid yet flexible material such as, without limitation, plastic as is well-known; for example, polytetrafluoroethylene (PTFE), polyvinyl chloride (PVC), polypropylene (PP), and the like.

With continuing reference to FIGS. 1 and 2A, and further reference to FIGS. 2B-2D, an exemplary filtering mask 100 further includes four strap couplings 121 on the mask body 110, with two of the strap couplings 121 on each of two opposing sides of the mask body 110. A strap 120 is detachably connected to the mask body 110. The strap 120 includes a belt portion 127 with Y-shaped junctions 125 at opposite ends of the belt portion 127. Two free ends 126 of the strap 120 extend from each of the Y-shaped junctions 125 and each free end 126 detachably connects to a corresponding strap coupling 121 via connecting holes 122. Each free end 126 may have several connecting holes 122 respectively positioned at different lengths along the free end 126, making the strap 120 adjustable in length. The strap 120 is formed from an elastic material such as, without limitation, silicon. The strap couplings 121 allow rotation of the connecting holes 122 around the strap coupling 121. Thus, the strap 120 may contribute to providing a comfortable but protective fit for each individual user, despite variation in body types and activities of a person.

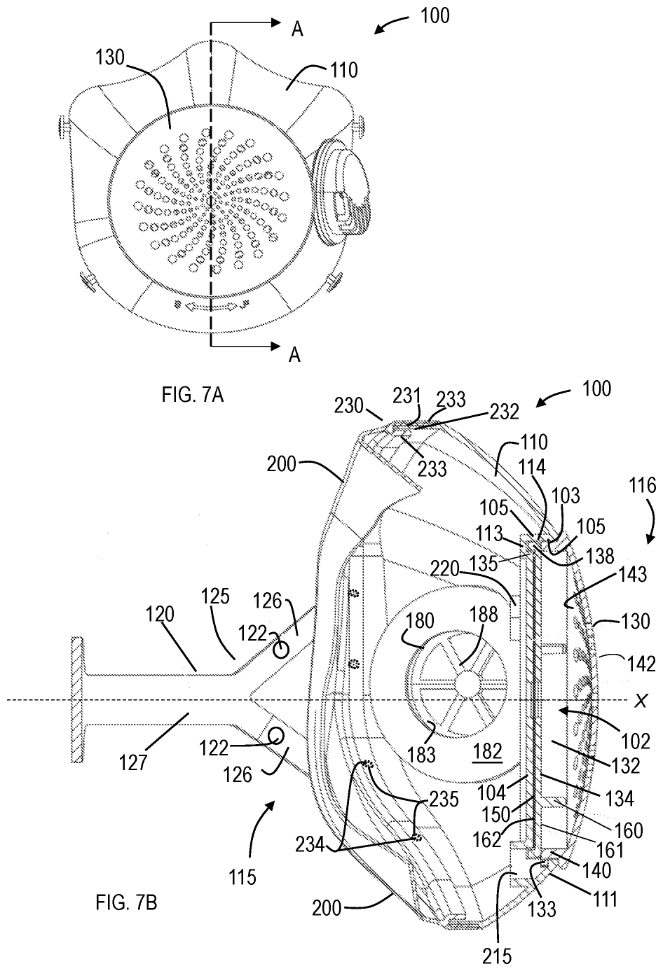

With additional reference to FIGS. 2E and 2F, and as discussed further below with respect to FIG. 7B, an exemplary filtering mask 100 further includes a valve port 180 in the mask body 110. The valve port 180 extends through the mask body 100, from the outer surface 111 of the mask body 110 to the inner surface 112 of the mask body 110 and is open to each of the outside 116 of the mask body 110 and the inner side 115 of the mask body 110. The valve port 180 is circumscribed by a valve mounting region 182 that is an annular region configured coaxially with the valve port 180. The valve mounting region 182 is configured and formed as a flattened portion of the outer surface 111 of the mask body 110, such that it does not include the curvatures or contours of the outer surface 111 of the mask body 110. A breathing valve 190 is connected over the valve port 180 via the valve mounting region 182. In the exemplary embodiments shown in, e.g., FIGS. 1, 2B, 2C, and 7B, the breathing valve 190 is a round, one-way air valve. In other embodiments, the breathing valve 190 may be square or have any geometry consistent with the disclosure.

The breathing valve 190 is formed from, without limitation, a breathing valve installation platform 181, a membrane (not shown), and a valve shell 185. The valve installation platform 181 is joined to the flattened valve mounting region 182 at a disk-shaped base 187 of the valve installation platform 181. A valve membrane frame 183 of the breathing valve installation platform 181 extends upwardly from the base 187 and includes a spoked frame 188 on which the membrane (not shown) may be positioned. The breathing valve installation platform 181 is annular and coaxial with the valve port 180. Connecting pins 184 are positioned in the center of the spoked frame 188 and around the base 187. The valve shell 185 is connected to the valve installation platform 181 via slots (not shown) on the valve shell 185 corresponding to the connecting pins 184. The valve shell 185 includes vents 186 for passing air out of the mask body 110—according to known techniques, the spoked frame 188 is bowed inwardly towards the inner side 115 of the mask body 110 such that when air is pushed out of the mask body 110 the membrane flexes away from the spoked frame 188 and allows the air to pass, but airflow in the direction towards the inner side 115 of the mask body 110 presses and seals the membrane against the spoked frame 188.

In an aspect, the breathing valve 190 may be removably secured to the mask body 110 such that the breathing valve 190 may be removed from the mask body 110 in certain situations, such as in schools, airplanes, hospitals, or spaces with vulnerable groups or closed spaces, in which exhaling air into the environment is disfavored or prohibited. The breathing valve 190 may be removably secured to the mask body 110 by any technique consistent with this disclosure. In an exemplary embodiment of this aspect, the breathing valve 190 is secured magnetically to the mask body 110. In such exemplary embodiment, the valve mounting region 182 may include, without limitation, an annular magnet (not shown) positioned on and secured to the valve mounting region 182. A passage through the annular magnet may align with the valve port 180. The disk-shaped base 187 of the valve installation platform 191 may include on a bottom surface (not shown), i.e., a surface of the base 187 that abuts the valve mounting region 182, an annular magnet that has an attractive force to the annular magnet on the valve mounting region 182. The annular magnet on the base 187 may be complementarily dimensioned and positioned to cooperate with the annular magnet on the valve mounting region 182, to secure the base 187 (and thereby the breathing valve 190) thereto, via the magnetic connection. In a state of use, the breathing valve 190 may be positioned and secured in place above the valve port 180 in the same relative alignment as described generally, above, with respect to the assembly between the valve port 180, the valve mounting region 182, and the breathing valve 190.

In the event that a user wishes to remove the breathing valve 190 according to the exemplary aspects described above, the breathing valve 190 may be disconnected from the mask body 110 merely by overcoming the force between the annular magnets connecting the valve mounting region 182 to the base 187 of the valve installation platform 191. When the breathing valve 190 is removed, a disk-shaped or other sealing structure dimensioned to cover the valve port and with a configuration that similarly includes a magnet on a surface against which the valve mounting region 182 will abut may be placed over the valve port 180 and magnetically connected to the annular magnet on the valve mounting region 182, to secure the sealing structure above the valve port 180 and effectively block a user's exhaled air from escaping the mask through the valve port 180. The sealing structure may be similarly removed, and the breathing valve 190 reattached, when the breathing valve 190 is once again permitted/desired.

In an aspect, the breathing valve 190, e.g., on the valve shell 185, and the sealing structure may include designs, pictures, or other surface features that enhance aesthetics, personalization, fashionability, etc. The valve shell 185, breathing valve 190, and sealing structure may also be interchangeable with other such structures to provide a variety of expressive aspects.

An exemplary filtering mask 100 also includes an elastic face seal 200 on the inner side 115 of the mask body 110. As described further below with respect to FIG. 7B, the elastic face seal 200 is connected to the mask body 110. The elastic face seal 200 has an ergonomically designed formed portion 202 configured for conforming, as a border with an open middle, around the nose and mouth of a user while the user's nose and mouth are received through the open middle into a breathing space 210. In an aspect, the elastic face seal 200 may be formed, without limitation, from silicone. The elastic face seal 200 includes barrier portions 201 that extend from the formed portion 202 to the mask body 110 at positions, such as around the top of a user's nose, where the formed portion 202 narrows relative to the mask body 110. The barrier portions 201 may enhance the seal between the elastic face seal 200 and the user's face, for example by sealing against portions of a user's cheeks, under their eyes, or any other portion of a unique user's face against which the barrier portions 201 are in contact. A breathing space 210 in which a user's nose and mouth will be positioned is defined by and between the mask body 110 and the elastic face seal 200.

With reference now to FIG. 3, an exemplary embodiment of the filtering mask 100 with the replaceable filter 150 inserted into the filter compartment 102 is shown. As discussed further below with respect to FIGS. 4-7B, the filter compartment 102 of the exemplary filtering mask 100 may be opened to access and replace the replaceable filter 150 and/or other components as discussed throughout this disclosure, and closed/locked to hold the replaceable filter 150 and/or other components in place during use.

With continuing reference to FIG. 3 and reference back to FIG. 1, a portion 153 (demarcated by dashed line as a portion of the periphery of the replaceable filter 150, for ease of reference and illustration and without limitation) of the replaceable filter 150 overlaps a recessed channel 114 with a frame support track 113 (discussed further below) when the replaceable filter 150 is positioned within the filter compartment 102 of the exemplary embodiment. The recessed channel 114 is defined in part by and between the peripheral wall 135 of the first filter frame 104 and the sidewall 105 of the filter passage 103. The replaceable filter 150 being dimensioned such that the replaceable filter 150 includes a portion 152 that overlaps the recessed channel 114 ensures that the replaceable filter 150 will cover all of the gaps 152 that allow air to flow from outside 116 of the mask 100 to the inner side 115 of the mask 100. Thus, all of the air passing through the mask body 110 via the filter passage 103 will be filtered by the replaceable filter 150 before arriving at the inner side 115 of the mask 100.

In the exemplary embodiment shown in FIG. 3 (see also FIG. 7B), the replaceable filter 150 is generally flat—i.e., the replaceable filter 150 has a top planar surface 154 parallel and opposite to a bottom planar surface 155 (shown with dashed line in phantom). In an aspect, the replaceable filter 150 may be formed from, for example and without limitation, one or more air filtering sheets such as melt-blown cloth, polytetrafluoroethylene (PTFE) nano-membrane, activated carbon, and silver ion cloth. In another aspect, the replaceable filter 150 may include one or more of essential oils, fragrances, and the like. Essential oils such as eucalyptus oil, peppermint oil, lavender oil, etc. may be pleasant to smell and have benefits such as calming stress, clearing airways, etc. Essential oils may also enhance certain activities in which such scents are common, e.g., yoga classes and spas, but are not used during group activities in which participants are required to wear masks. Fragrances may freshen the air in the mask in a pleasant manner, for simple enjoyment or to mask foul odors in a user's environment. The essential oils and fragrances and the experiences that they create are not necessarily exclusive to protective use with the mask—they may be therapeutic even when personal protection is not required.

Oil or other scented materials or additives may be added to the replaceable filter 150 by, e.g., smearing or dousing a top layer of non-woven cloth on the replaceable filter 150 with oil, cream, fibers, or whatever medium the additive takes. Alternatively, a top layer of non-woven cloth that is pre-infused with the additive may be included as the top layer of the replaceable filter 150 material/structure.

In other exemplary embodiments, the replaceable filter 150 may include a picture, design, coloration, or other personalization or fashion aspect. For example, the replaceable filter 150 may include a picture printed thereon according to known techniques. The picture may be visible through a clear filter compartment cover 130 to add additional aesthetics and personalization. Other design and personalization options associated with the replaceable filter 150 may be used consistent with this disclosure and without impeding the function of the replaceable filter 150.

While the replaceable filter 150 and other components of the exemplary filtering mask 100 have been shown and described in this disclosure according to the exemplary configurations, geometries, dimensions, techniques, etc., the disclosure is not so limited and many variations consistent with this disclosure of the exemplary embodiments exist and are contemplated according to the disclosure. For example, the filter compartment 102 may be configured in any workable geometry and is not limited to a cylindrical geometry or circular profile/cross section. The first filter frame 104 including the web of support structures 151 may, in alternative embodiments, be any design consistent with this disclosure and may include, e.g., one or more discontinuous support structures, support structures integral with and extending from the mask body 110, lattices of various materials capable of supporting and securing the replaceable filter 150 consistent with this disclosure, etc.

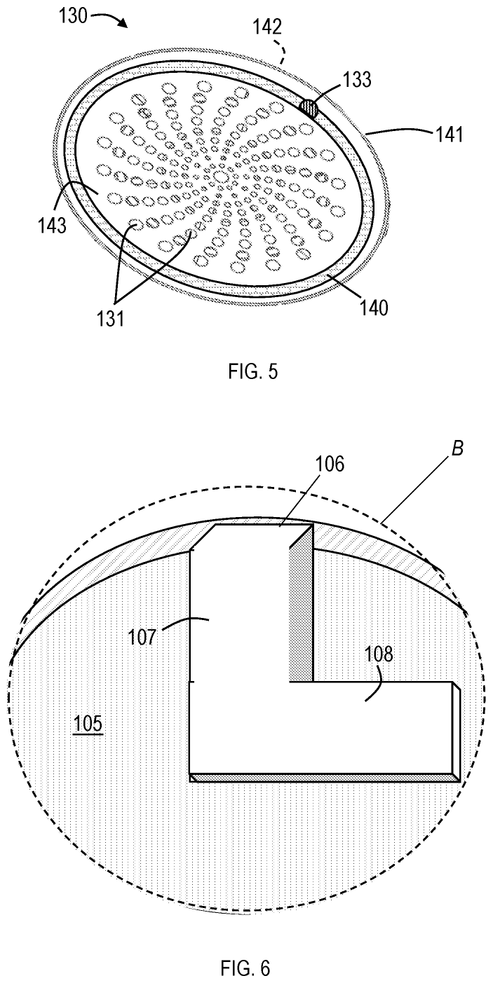

With reference now to FIG. 4 and FIG. 5, the exemplary embodiment further includes a filter compartment cover 130 including at least one ventilation hole 131 through the filter compartment cover 130. In the exemplary embodiment shown in FIG. 4, a plurality of ventilation holes 131 are formed through the filter compartment cover 130 and arranged in a spiral pattern. The filter compartment cover 130 provides a solid barrier to particulates while the ventilation holes 131 disrupt the overall air intake and thereby create flow inside the filter compartment 102 which allows the replaceable filter 150 to reduce penetration even further. For example, a large plurality of ventilation holes 131 arranged in a spiral pattern as shown in FIG. 4, in which ventilation hole diameters decrease as between ventilation holes 131 on the outside and ventilation holes 131 towards the center, may increase circulation within the filter compartment 102 and provide more contact with the replaceable filter 150 and thereby more removal of particulates from the air. Whether functional or not, any arrangement of ventilation holes 131 consistent with this disclosure may be used.

The filter compartment cover 130 in the exemplary embodiment serves as a cover for the filter compartment 102, specifically as a cover at the outside opening 117 of the filter passage 103. The filter compartment cover 130 is generally aligned on the filter compartment 102/mask body 110 along an axis ‘x’ that represents an axis that will (conceptually) align, generally and without limitation, between a user's mouth and nose when wearing the mask 100. The filter component cover 130 is configured for being reversibly connected and locked to the mask body 110, as discussed below. For purposes of this disclosure, “reversibly connected and locked” means attached in a secure manner but capable of being disconnected by particular action(s) or mechanism(s) and subsequently reattached in the secure manner. The exemplary filter compartment cover 130 shown in FIG. 5 includes a hood portion 141 that is positioned above and covers all of the outside opening 117 of the filter passage 103. The hood portion 141 has an outside surface 142 and an inside surface 143. A portion of the filter compartment cover 130 is configured as a skirt 140 that extends downwardly—i.e., away—from the inside surface 143 of the hood 141 of the filter compartment cover 130. The skirt 140 and the filter passage 103 are cooperatively dimensioned for the skirt 140 to be received within the filter passage 103 via the outside opening 117.

In an aspect, the skirt 140 interacts with a portion of the filter compartment 102, to reversibly connect and lock the filter compartment cover 130 to the mask body 110. In the exemplary embodiments shown in, e.g., FIGS. 1, 3, and 6, the sidewall 105 includes a sidewall slot 106 (FIG. 6, detail ‘B’ in FIG. 1) formed in the sidewall 105 and the filter compartment cover 130 includes a corresponding filter compartment cover tab 133 formed on the skirt 140. The filter compartment cover tab 133 is dimensioned for being received within the sidewall slot 106 when the skirt 140 is received in the filter passage 103. The sidewall slot 106 includes an axial portion 107 and a transverse portion 108 together dimensioned for the filter compartment cover tab 133 to be received within the axial portion 107 and then moved, for example by rotating the filter compartment cover 130, from within the axial portion 107 to within the transverse portion 108. The filter compartment cover tab 133 positioned within the axial portion 107 defines an unlocked state of the filter compartment cover 130, from which the filter compartment cover 130 may be removed from the filter compartment 102 and the mask body 110. The filter compartment cover tab 133 positioned within the transverse portion 108 defines a locked state of the filter compartment cover 130, in which the filter compartment cover 130 is secured in position on the filter compartment 102/mask body 110. In the exemplary embodiments shown, e.g., in FIGS. 1 and 2E, a lock/unlock indicator 139 is printed on the mask body 110 to indicate the direction in which to rotate the filter compartment cover 130 for each state. The filter compartment cover 130 may be removed from the filter compartment 102 to access the components therein, change the replaceable filter 150, etc., and then securely reattached to the filter compartment 102 before using the mask 100.

In various embodiments, the skirt 140 and the sidewall 105 may include any number of corresponding engagement structures, such as the filter compartment cover tab 133 and the sidewall slot 106 as in the exemplary embodiments. In other embodiments, the engagement structures or techniques may be any structures or techniques consistent with this disclosure; for example and without limitation, magnetic junctions, positive locking between resilient structure(s), positive locking by biasing mechanisms, and the like. In various embodiments, the engagement structures may be positioned on a structure such as the skirt 140 or may be discrete structures/features. In other embodiments, the skirt 140 or another structure of the filter compartment cover 130 may be dimensioned to frictionally engage and thereby lock to the sidewall 105 in a manner that may be disengaged (i.e., unlocked) by applying a certain amount of force in a certain direction.

In various aspects, the mask body 110, filter compartment cover 130, and/or other components of the mask 100 may include, for example, designs, text, images, accessories, and the like, to further personalize and conventionalize protective masks as a fashion item. A variety of filter compartment covers 130 having various designs may be interchangeable with masks having various designs to create further design combinations.

With reference to FIGS. 7A and 7B, a cross-section (FIG. 7B) of the exemplary filtering mask 100 along plane A-A (FIG. 7A) is shown. As shown, among other things, in FIG. 7B, a filter gap 132 is defined between the first filter frame 104 and an inside surface 143 of the hood 141 of the filter compartment cover 130 and bounded by the skirt 140 at one portion and by the sidewall 105 at another portion. For ease of reference with respect to the exemplary embodiments of the filter compartment 102 and the filter gap 132, the first filter frame 140 in the exemplary embodiments is formed integrally with and includes the frame support track 113. The filter gap 132 may be used to house additional components of the filtering mask 100 according to various exemplary embodiments.

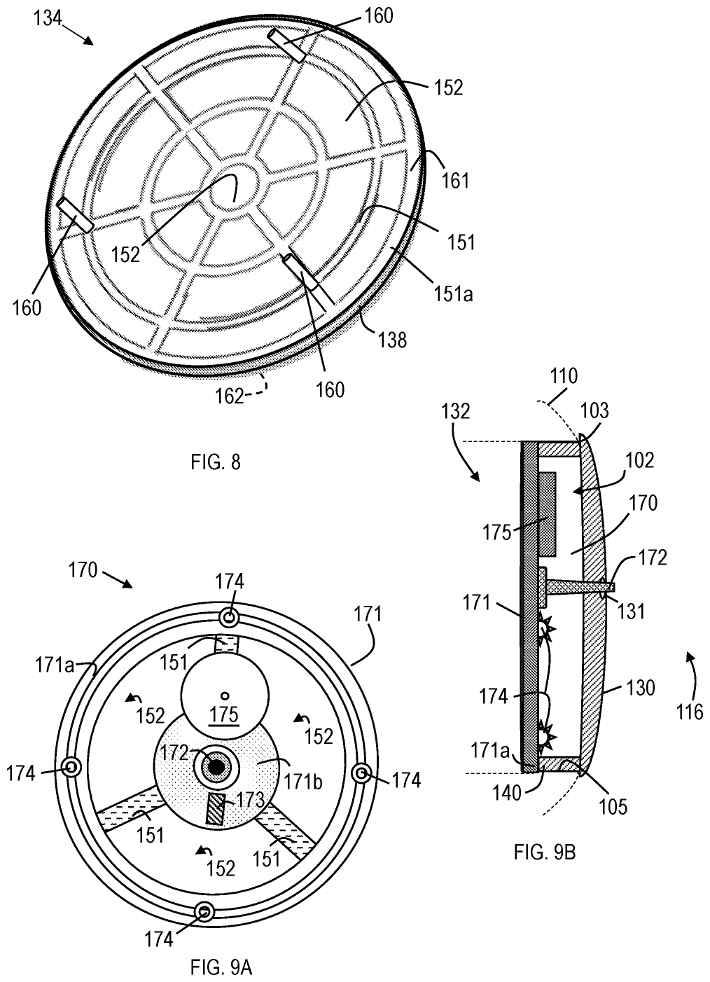

For example, in the exemplary embodiment shown in FIG. 7B, and with further reference to FIG. 8, a second filter frame 134 is positioned within the filter gap 132. The second filter frame 134 includes a web of solid supports 151 interspersed with gaps 152 in the same manner discussed above with respect to the first filter frame 104. The second filter frame 134 is dimensioned for, among other things, being positioned above the replaceable filter 150 within the filter gap 132. A bottom surface 162 of the second filter frame 134 abuts a portion of the replaceable filter 150 when assembled within the filter gap 132. A downwardly extending rim 138 is positioned at a periphery of the second filter frame 134 and extends in a direction away from the bottom surface 162 of the second filter frame 134. The downwardly extending rim 138 in the exemplary embodiments is an integral portion of an outermost solid support 151a of the second filter frame 134, extending at an angle therefrom. In other embodiments, the downwardly extending rim 138 may be formed as a separate structure attached by techniques consistent with this disclosure, such as, for example and without limitation, adhesives, mechanical connections, and the like.

With continuing reference to the exemplary embodiments shown in, e.g., FIGS. 7B and 8, the second filter frame 134 including the downwardly extending rim 138 is dimensioned such that the downwardly extending rim 138 is received within the recessed channel 114 when the second filter frame 134 is received within the filter gap 132. The recessed channel 114 is defined by the sidewall 105, the peripheral wall 135 of the first filter frame 104, and the frame support track 113. In an aspect, the sidewall 105 and the peripheral wall of the first filter frame 104 are coaxial and the frame support track 113 extends from the sidewall 105 to the peripheral wall 135 of the first filter frame 104. In another aspect, the sidewall 105, the first filter frame 104 including the peripheral wall 135, and the frame support track 113 are integrally formed, e.g., by injection molding, with and as features of the mask body 110, including the outer surface 111 and the inner surface 112 between which the sidewall 105 extends. Accordingly, in an exemplary embodiment, the mask body 110 may be formed as a unitary structure including the sidewall 105 and the first filter frame 104, which may include and define the frame support track 113 and the pad slots 215. In a further aspect, the mask body 110 as a unitary structure may include the strap couplings 121.

The replaceable filter 150 is positioned between the first filter frame 104 and the second filter frame 134. The portion 153 of the replaceable filter 150 that overlaps the recessed channel 114 is positioned and retained between the downwardly extending rim 138 and at least the peripheral wall 135 of the first filter frame 104. Retaining the replaceable filter 150 in this manner may, at least in part, secure the replaceable filter 150 in position within the filter compartment 102, such that the replaceable filter 150 extends over the entire area of gaps 152 formed in the first filter frame 104. Depending on a diameter of the replaceable filter 150, and a corresponding distance to which it may overlap or extend beyond the recessed channel 114, portions of the replaceable filter 150 may also be retained between the downwardly extending rim 138 of the second filter frame 138 and the frame support track 113 and further the sidewall 105. Pads 220 positioned in pad slots 215 that extend into the hollow recess 114 are formed from a material, such as rubber and the like, that can retain the replaceable filter 150 and/or second filter frame 134 with a greater degree of friction than, e.g., an injection molded plastic.

In an aspect, the exemplary embodiments of a second filter frame shown in FIGS. 7B and 8 include one or more positioning posts 160 extending from a top surface 161 of the second filter frame 134, in a direction away from the top surface 161. The positioning posts 160 may be dimensioned for, without limitation, extending between the second filter frame 134 and the filter compartment cover 130 such that the second filter frame 134 and thereby the replaceable filter 150 are maintained in place within the filter compartment 102.

With continuing reference to FIG. 7B, the elastic face seal 200 may be formed as a single piece and connected to the mask body 110. In the exemplary embodiment shown in FIG. 7B, a sealing edge 230 of the elastic face seal 200 has a U-shaped cross section forming a cavity 231 bounded by inner and outer edge walls 233, within which an outer edge 232 of the mask body 110 is received. In an aspect, an adhesive is deposited within the cavity 231, for securing the outer edge 232 of the mask body 110 within the cavity 231. In another aspect, each of the inner and outer edge walls 233 is secured by adhesive to the outer edge 232 of the mask body 110.

The cavity 231 according to the exemplary embodiment shown in FIG. 7B further includes fastening bridges 234 (shown in phantom in FIG. 7B) formed integrally with the sealing edge 230, within the cavity 231. The fastening bridges 234 may be pressed into corresponding notches 235 that are formed in the outer edge 232 of the mask body 110, to provide additional connections between the elastic face seal 200 and the mask body 110.

With reference to FIGS. 9A and 9B, a light 170 configured as a light insert for the filtering mask may be positioned within the filter gap 132 and dimensioned according to the disclosure. The exemplary light 170 may include, without limitation, a printed circuit board (PCB) 171, a control button 172, a controller 173 such as a processor, switch, or other electrical control component or integrated circuit component, or the like as applications dictate, light sources 174, and a battery 175. In the exemplary embodiments shown in FIGS. 9A and 9B, the PCB 171 is configured with a peripheral PCB portion 171a, a central PCB portion 171b, and solid supports 151 arranged as spokes between the peripheral PCB portion 171a and the central PCB portion 171b in the same manner as solid supports described above with respect to the first filter frame 104 and the second filter frame 134. Each of the peripheral PCB portion 171a, the central PCB portion 171b, and the solid supports 151 may be configured with electrical relays and connections for providing power and control signaling variously between the battery 175, the control button 172, and the light sources 174. The light 170 includes gaps 152, similar to the first filter frame 104 and the second filter frame 134, between the solid supports 151. The gaps 152 again allow airflow through the PCB 171 from the outside 116 of the mask body 110 and through the replaceable filter 150 to the inner side 115 of the mask body 110.

With particular reference to FIG. 9B, a filter gap 132, among other things, of the exemplary filtering mask 100 as described throughout this disclosure is shown in isolation, for brevity and clarity. A description of the common features is not repeated here but forms a part of the description with respect to FIGS. 9A and 9B. For example, the filter gap 132 is positioned in part within a filter compartment 102 formed in a filter passage 103 through the mask body 110, indicated by dashed lines. The PCB 171 is shown in FIG. 9B within the filter gap 132 and, as indicated by dashed lines, the filter gap 132 extends further in an opposite direction from the filter compartment cover 130, to the first filter frame 104 according to the exemplary embodiments. In the exemplary embodiment as shown in FIG. 9B, the control button 172 may be aligned with a ventilation hole 131 of the filter compartment cover 130, to provide access to the control button 172 which may be pushed from the end of the control button 172 that extends to the outside 116 of the mask body 110. While only the ventilation hole 131 through which the control button 172 passes is shown in FIG. 9B, the filter compartment cover 130 may have any number of ventilation holes 131 in any configuration consistent with this disclosure, as previously discussed. The control button 172 may have a tapered design such that an end of the control button 172 opposite the PCB 171 passes through the ventilation hole 131 to a point at which the diameter of the control button 172 is too large to pass through the ventilation hole 131. A portion of the control button 172 at that point is accessible from the outside 116 of the mask body 110. For example, a portion of the control button 172 may either extend to the outside 116 of the mask body 110 or be positioned adjacent to the outside surface 142 of the hood 141 of the filter compartment cover 130. As used above, “adjacent” may mean at or near the outside surface 142 of the hood 141, provided that a user may push, turn, flip, or otherwise actuate the control button 172 via the accessible portion. This also allows the control button 172 to serve as a positioning post (i.e., 160 (FIG. 8)) for holding the light 170 and replaceable filter 150 in position, even if the second filter frame 134 is not used with the light 170. While not shown in FIG. 9B, the PCB 171 may abut the replaceable filter 150 in the same manner as the second filter frame 134 as described above.

In addition, as shown in FIG. 9B, the peripheral PCB 171a is dimensioned to align with the skirt 140 of the filter compartment cover 130 and configured such that the skirt 140 presses against and retains the PCB 171 in position within the filter gap 132, without damaging any components on the PCB 171. While not shown, the PCB 171 may also have a structure such as the downwardly extending rim 138 of the second filter frame 134 according to the exemplary embodiments described above, and such downwardly extending rim 138 may similarly fit into the recessed channel 114 of the first filter frame 104, to retain and maintain the position of the replaceable filter 150 within the filter compartment 102.

In various aspects, the light source(s), control techniques, assemblies, etc. may be of any number, geometry, arrangement, configuration, etc., consistent with this disclosure. In an exemplary embodiment, the light sources are individual light-emitting diodes (LEDs), the switch 173 controls power, via the battery, and flashing patterns to the light sources 174 are responsive to pressing the control button 172. For example, in a exemplary embodiment, one press may power on the light sources 174 in a first flashing pattern, a second press and a third press respectively change the flashing pattern, and a fourth press may power off the light sources 174. Other exemplary embodiments, components, configurations, functions, and uses include, without limitation and among other things, different light sources, control techniques, and arrangement of the light sources. For example, the light source(s) may be a light-emitting diode (LED) tube, photoluminescent materials, and the like. The light source(s) and controller(s) may be configured to form designs, text, various color and flashing patterns, and the like for personalizing and having fun with the mask. The light sources may be controlled manually or responsively to, e.g., one or more of an ambient light sensor, a motion sensor, a sound sensor (such that, for example, the lights are activated when a user speaks through the mask), and/or any known devices or techniques for controlling operation of a light source consistent with this disclosure. Exemplary, particular uses include attending sporting events with mask and/or light designs with team colors, logos, mottos, etc. The mask may be incorporated into Halloween costumes, for personal protection during trick-or-treating and to enhance costumes with Halloween imagery or fun lighting, or simply festive for holidays such as Christmas, Thanksgiving, while also providing personal protection when gathering for the occasions.

In a further aspect, the exemplary embodiments may also include in the filter gap 132 cloth layers infused with scents, essential oils, or other additives, and/or other components or features. Within the filter gap 132, according to the exemplary embodiments, any components or features included within the filter gap 132 must not impede sufficient airflow through the mask to the user. For example, components such as the second filter frame 134 may have interchangeable varieties with different artwork, designs, etc., that may be visible through a clear filter compartment cover 130.

In a further aspect, and with reference back to FIG. 2A, the volume of the breathing space 210, including the setoff between a user's face against the elastic face seal 200 and the inner surface 112 of the mask body 110, may provide additional area in which, e.g., temperature and fragrance control may be achieved. The inner surface 112 of the mask body 110, within the breathing space 210, may, for example, by formed with integral moldings, fittings, receptacles, retainers, etc., dimensioned to receive complementarily fragrance pads, infusions, drops, and the like. In addition or alternatively, a frozen liquid-gel pack that cools the air through the mask on hot days or during strenuous activities may be positioned within the breathing space 210. In an exemplary embodiment, the frozen liquid-gel pack is placed in the freezer and, when ready for use, affixed to the inner surface 112 of the mask body 100, within the breathing space 210. The frozen liquid-gel pack may be custom formed to fit within an integral structure or surface feature on the inner surface 112 of the mask body 100, as discussed above. In an exemplary embodiment, the frozen liquid-gel pack is formed to fit along a perimeter of the filter passage 103 and breathing valve 190. In other embodiments, the frozen liquid-gel pack may be formed to follow the contours of the inner surface 112 of the mask body 110. In those or other embodiments in which the frozen liquid-gel pack may be a conventional-type frozen liquid-gel pack, it may removably attach to the inner surface 112 by adhesive or other known techniques.

In view of the various aspects of the exemplary embodiments of a filtering mask 100 as discussed throughout this disclosure, the exemplary filtering mask 100 may be used in circumstances where personal protection is not necessarily required but fun, therapeutic, or comfortable aspects of such a mask may be desired.

The disclosure also relates generally to a method for inserting or replacing a replaceable filter in a filtering mask 100 according to the exemplary embodiments shown in the figures and described throughout this disclosure, which descriptions are not repeated here but form part of the disclosure of the exemplary method(s). According to an exemplary embodiment, the method of replacing a replaceable filter in the filtering mask includes unlocking and removing a filter compartment cover from a filter compartment formed on a mask body of the filtering mask. In an aspect, the method may include removing a spent filter, e.g., a filter that is soiled, damaged, old, etc., from the filter compartment. The exemplary method further includes inserting a fresh filter into the filter compartment. In an aspect, the method may include positioning the fresh filter within the filter compartment, e.g., on a first filter frame. The exemplary method further includes replacing and locking the filter compartment cover on the filter compartment.

In an aspect, the method may further include removing one or more retaining structures for the replaceable filter, an accessory, or a component. For example and without limitation, the retaining structure may be a frame or a PCB and the accessory or the component may be a PCB, a light source, a scented or infused cloth or secondary filter, or other accessory or component consistent with this disclosure.

In an aspect, the filter compartment may be a volume bounded by a sidewall and a bottom support structure, the sidewall may have a sidewall connector that is cooperative with a filter compartment cover connector on the filter compartment cover for connecting and locking the filter compartment cover to the filter compartment. In another aspect, the sidewall connector may be a slot that includes an axial portion and a transverse portion together dimensioned for a filter compartment cover tab to move between, in either direction, the axial portion and the transverse portion. The filter compartment cover tab in the axial portion may define an unlocked state of the filter compartment cover and the step(s) of unlocking and removing the filter compartment cover may include positioning the filter compartment cover tab in the axial portion, which may include moving the filter compartment cover tab from the transverse portion to the axial portion. The filter compartment cover tab in the transverse portion defines a locked state of the filter compartment cover and the step(s) of replacing and locking the filter may include inserting the filter compartment cover tab into the axial portion and moving the filter compartment cover tab to the transverse portion. In an aspect, moving the filter compartment cover tab may include rotating the filter compartment cover relative to the filter compartment.

In the same or other embodiments, the step of locking the filter compartment cover on the filter compartment may include frictionally engaging cooperative structures or surfaces respectively on the filter compartment cover and within the filter compartment, or on the sidewall. In such embodiments, the step of unlocking the filter compartment cover may include applying a sufficient force in a direction for overcoming the frictional engagement between the cooperative structures.

In an aspect, the method may further include applying an additive to the fresh filter. The additive may be, without limitation, an essential oil or fragrance.

In an aspect, the method may further include inserting an accessory or component into a filter gap portion of the filter compartment. The accessory or component may be, without limitation, a PCB, a light source, a scented or infused cloth or secondary filter, or an electronic accessory, consistent with this disclosure.

In an exemplary embodiment, a method of use of the exemplary embodiments of a filtering mask includes placing an elastic seal portion of the filtering mask around a nose and mouth, and positioning the nose and mouth in a breathing space defined by the elastic seal portion on one side and a mask body on the opposite side. The exemplary method may further include adjusting a length of a strap coupled to the mask, which may include selecting one of a plurality of length adjustments holes on one or more free ends of the strap and coupling the selected length adjustment hole to a strap coupling on the mask body. The exemplary method may further include placing the strap around a user's head.

It is believed that the exemplary embodiments of a filtering mask may use as little or less than ⅙^{th} of the filtering material required for a typical disposable filtering mask. A filtering mask according to the exemplary embodiments may therefore have the benefit of reducing the consumption of filter materials such as fabrics and eliminate for the life of the filtering mask other disposable mask components and materials, such as nose clips and straps, and power consumption for mask production, to a degree corresponding to a particular user's consumption of conventional disposable masks.

This disclosure, in various embodiments, configurations and aspects, includes components, methods, processes, systems, and/or apparatuses as depicted and described herein, including various embodiments, sub-combinations, and subsets thereof. This disclosure contemplates, in various embodiments, configurations and aspects, the actual or optional use or inclusion of, e.g., components or processes as may be well-known or understood in the art and consistent with this disclosure though not depicted and/or described herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

In this specification and the claims that follow, reference will be made to a number of terms that have the following meanings. The terms “a” (or “an”) and “the” refer to one or more of that entity, thereby including plural referents unless the context clearly dictates otherwise. As such, the terms “a” (or “an”), “one or more” and “at least one” can be used interchangeably herein. Furthermore, references to “one embodiment”, “some embodiments”, “an embodiment” and the like are not intended to be interpreted as excluding the existence of additional embodiments that also incorporate the recited features. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Terms such as “first,” “second,” “upper,” “lower” etc. are used to identify one element from another, and unless otherwise specified are not meant to refer to a particular order or number of elements.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

As used in the claims, the word “comprises” and its grammatical variants logically also subtend and include phrases of varying and differing extent such as for example, but not limited thereto, “consisting essentially of” and “consisting of.” Where necessary, ranges have been supplied, and those ranges are inclusive of all sub-ranges therebetween. It is to be expected that the appended claims should cover variations in the ranges except where this disclosure makes clear the use of a particular range in certain embodiments.

The terms “determine”, “calculate” and “compute,” and variations thereof, as used herein, are used interchangeably and include any type of methodology, process, mathematical operation or technique.

This disclosure is presented for purposes of illustration and description. This disclosure is not limited to the form or forms disclosed herein. In the Detailed Description of this disclosure, for example, various features of some exemplary embodiments are grouped together to representatively describe those and other contemplated embodiments, configurations, and aspects, to the extent that including in this disclosure a description of every potential embodiment, variant, and combination of features is not feasible. Thus, the features of the disclosed embodiments, configurations, and aspects may be combined in alternate embodiments, configurations, and aspects not expressly discussed above. For example, the features recited in the following claims lie in less than all features of a single disclosed embodiment, configuration, or aspect. Thus, the following claims are hereby incorporated into this Detailed Description, with each claim standing on its own as a separate embodiment of this disclosure.

Advances in science and technology may provide variations that are not necessarily express in the terminology of this disclosure although the claims would not necessarily exclude these variations.

1. A filtering mask for use with a replaceable filter, comprising:
a mask body;
a filter passage formed through the mask body, from an outside opening of the filter passage to an inside opening of the filter passage, wherein the filter passage is bounded by a sidewall extending from an outer surface of the mask body to an inner surface of the mask body;
a first filter frame positioned adjacent to the inside opening of the filter passage, wherein the sidewall, the first filter frame, and the filter passage define a filter compartment; and
a filter compartment cover including a ventilation hole through the filter compartment cover, wherein a portion of the filter compartment cover is positioned within the filter passage and a filter gap is defined between the first filter frame and the filter compartment cover.

2. The filtering mask of claim 1, further comprising a replaceable filter positioned on the first filter frame.

3. The filtering mask of claim 2, wherein the replaceable filter is formed from at least one of melt-blown cloth, polytetrafluoroethylene (PTFE) nano-membrane, activated carbon, and silver ion cloth.

4. The filtering mask of claim 2, wherein the replaceable filter includes at least one of an essential oil and a fragrance.

5. The filtering mask of claim 2, further comprising a second filter frame, wherein the second filter frame is positioned on the replaceable filter, such that the replaceable filter is positioned between the first filter frame and the second filter frame.

6. The filtering mask of claim 5, wherein a frame support track is positioned between a peripheral wall of the first filter frame and the sidewall, the second filter frame includes a downwardly extending rim, and at least a portion of the downwardly extending rim is positioned within the frame support track.

7. The filtering mask of claim 6, wherein a portion of the replaceable filter overlaps the frame support track and is retained between the downwardly extending rim and one or both of a portion of the first filter frame and the frame support track.

8. The filtering mask of claim 2, further comprising a light positioned above the replaceable filter, within the filter gap.

9. The filtering mask of claim 8, wherein the light includes a printed circuit board (PCB), at least one light source electrically connected to the PCB, and a control button electrically connected to and extending away from the PCB, wherein the control button is axially aligned with the ventilation hole through the filter compartment cover and a portion of the control button is accessible from an outside of the mask body.

10. The filtering mask of claim 9, wherein the control button controls at least one of a light pattern, a color pattern, a flashing pattern, and an on/off function of the at least one light source.

11. The filtering mask of claim 1, wherein the sidewall includes a sidewall slot formed in the sidewall and the filter compartment cover includes a filter compartment cover tab formed on the portion of the filter compartment cover positioned within the filter passage and cooperatively mated with the sidewall slot.

12. The filtering mask of claim 11, wherein the sidewall slot includes an axial portion and a transverse portion, wherein
in a first state, the filter compartment cover tab is positioned in the axial portion; and
in a second state, the filter compartment cover tab is positioned in the transverse portion.

13. The filtering mask of claim 12, wherein the filter compartment cover tab is movable between the axial portion and the transverse portion, in response to rotation of the filter compartment cover.

14. The filtering mask of claim 1, further comprising a valve port formed through the mask body, and a breathing valve positioned over the valve port, wherein the breathing valve is a one-way valve for allowing airflow only from an inner side of the mask body to an outside of the mask body.

15. The filtering mask of claim 14, further comprising an elastic face seal positioned on the inner side of the mask body and connected to the mask body at a sealing edge of the elastic face seal, wherein the elastic face seal includes a formed portion configured for receiving a nose and mouth into a breathing space between the elastic face seal and the mask body and each of the valve port and the filter passage are open to the breathing space.

16. (canceled)

17. (canceled)

18. (canceled)

19. A light insert for use with a filtering mask, comprising:
a printed circuit board (PCB), wherein the PCB and a filter compartment of the filtering mask are cooperatively dimensioned for the PCB to be received within the filter compartment;
an airflow gap through the PCB;
a light source; and
a controller electrically connected to the PCB and operative to control operation of the light source.

20. The light insert of claim 19, wherein the controller is at least one of a button, an ambient light sensor, a motion sensor, and a sound sensor.

21. The filtering mask of claim 14, wherein the breathing valve is magnetically coupled to the valve port.

22. The filtering mask of claim 21, wherein the breathing valve is removable from the valve port and interchangeable with a valve port seal, wherein the valve port seal is configured for magnetically coupling to the valve port and preventing airflow through the valve port.

23. A removable breathing valve for a face mask, comprising:
a shell;
a vent; and
a magnetic coupling, the magnetic coupling configured for removably, magnetically coupling the removable breathing valve to a complementarily configured valve port.
